(19) United States
(12) Patent Application Publication
(10) Pub. No.: US 2006/0224781 A1
(43) Pub. Date: Oct. 5, 2006

(54) METHOD AND APPARATUS FOR CONTROLLING A USER INTERFACE OF A CONSUMER ELECTRONIC DEVICE

(76) Inventors: Jen-Ming Tsao, Taipei Hsien (TW); Yuan-Ching Lin, Hsin-Chu Hsien (TW); Chih-Hung Cheng, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/906,870

(22) Filed: Mar. 10, 2005

(51) Int. Cl. G06F 3/00

(52) U.S. Cl. 710/15

(57) ABSTRACT

Methods and systems for controlling a user interface of a consumer electronic device. An exemplary embodiment of a method for controlling a user interface of a consumer electronic device, including a plurality of I/O interfaces for communication with a plurality of data sources, is disclosed. The method comprises: utilizing the user interface to display a content list of a first data source present in the consumer electronic device if the first data source is active; and when a second data source is added to the consumer electronic device and then actively selected, utilizing the same user interface to display a content list of the second data source.

### BACKGROUND

The present invention relates to user interfaces of consumer electronic devices, and more particularly, to a method and apparatus for controlling a user interface of a consumer electronic device.

The design of electronic devices usually provides a user interface through which users can control the device. Whether a user interface is friendly or not usually defines the convenience of the electronic device, and it certainly affects the user's desire to purchase and utilize the electronic device in daily life. Moreover, the friendliness of the user interface is critical for an electronic device that supports multiple functions because such an electronic device usually requires a plurality of user interfaces for users to maneuver the multiple functions. As a result, users must learn hard in order to adapt to the plurality of user interfaces before they can easily utilize the multiple functions provided by the electronic device. This issue is especially important for today's consumer electronic devices because they have been equipped with more and more functions for users to use.

The conventional user interface of a consumer electronic device is designed for users to manipulate the device in various ways to display the content of one particular data source. For example, the user interface of a DVD player includes a menu for users to choose a certain title to play audio and/or video data stored on an optical disc. However, because memory cards, such as compact flash (CF), secure digital (SD), or memory sticks (MS), have recently gained great popularity in the consumer storage media market, it is an emerging trend that consumer electronic devices provide the additional capability of accessing and utilizing an inserted memory card. The users may browse the content on more than one memory card in addition to the electronic device's original data source (e.g., the optical disc). In light of the need for the user to maneuver and switch among multiple data sources, a common and friendly user interface is desired to control a consumer electronic device with multiple functions.

### SUMMARY

Methods and systems for controlling a user interface of a consumer electronic device are provided. An exemplary embodiment of a method for controlling a user interface of a consumer electronic device, which includes a plurality of I/O interfaces for communication with a plurality of data sources, comprises: utilizing the user interface to display a content list of a first data source present in the consumer electronic device if the first data source is active; and when a second data source is added to the consumer electronic device and then actively selected, utilizing the same user interface to display a content list of the second data source.

Another embodiment of a method for controlling a user interface of a consumer electronic device is disclosed. The consumer electronic device is capable of communicating with a plurality of data sources. The embodiment of a method for controlling a user interface comprises: if a first data source is present in the consumer electronic device and being active, utilizing the user interface to display a content list of the first data source; and when a second data source is added to the consumer electronic device, utilizing the same user interface to display a content list of the second data source.

An exemplary embodiment of a consumer electronic device capable of communicating with a plurality of data sources comprises a storage unit for storing a user interface program and a controller coupled to the storage unit. The controller is operative to execute the user interface program and control a user interface shown on a display unit. The user interface is controlled to display a content list of a first data source present in the consumer electronic device if the first data source is active, and when a second data source is added to the consumer electronic device and then actively selected, the same user interface is controlled to display a content list of the second data source.

### BRIEF DESCRIPTION OF DRAWINGS

Methods and systems for controlling a user interface of a consumer electronic device can be more fully understood by reading the subsequent detailed description and examples with references made to the accompanying drawings, in which:

FIG. 1 is a block diagram of an exemplary embodiment of a consumer electronic device.

FIG. 2 is a block diagram of an exemplary embodiment of the software architecture for use in the consumer electronic device of FIG. 1.

FIG. 3 is a diagram illustrating an exemplary embodiment of a user interface.

FIG. 4 is an exemplary embodiment of a system flowchart of the consumer electronic device.

### DETAILED DESCRIPTION

A consumer electronic device, such as a DVD player, DVD recorder, MP3 player and portable media player, may have one or more built-in or external I/O interfaces that are utilized to access an optical disc as well as some storage media like memory cards or portable hard drives. Since the content may come from different data sources, a common user interface is constructed to present the content of the different data sources.

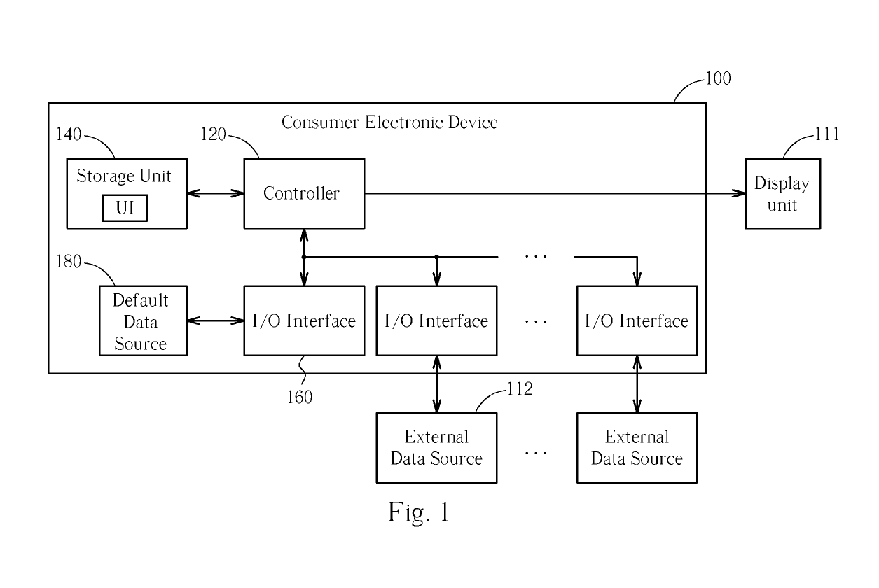

Please refer to FIG. 1, which is a block diagram illustrating an exemplary embodiment of a consumer electronic device 100. The consumer electronic device 100 includes a controller 120, a storage unit 140 (flash memory for example), and a plurality of I/O interfaces 160. The storage unit 140 is configured to store a user interface program UI, controller program, and associated data. One of the I/O interfaces 160 is utilized for accessing a default data source 180; the remaining I/O interfaces are utilized for accessing a plurality of external data sources 112. The default data source 180 and the external data sources 112 could be any storage media. For example, if the consumer electronic device 100 is a DVD player, the default data source 180 is an inserted optical disc, and the external data sources 112 include but are not limited to memory cards and portable hard drives.

The controller 120 is operative to execute the user interface program UI for control of a user interface shown on a display unit 111. In some embodiments, the display unit 111 is exterior to the consumer electronic device 100; alternatively, the consumer electronic device 100 could comprise the display unit 111 to show the user interface. The operation of controlling the user interface of the consumer electronic device 100 is detailed as follows.

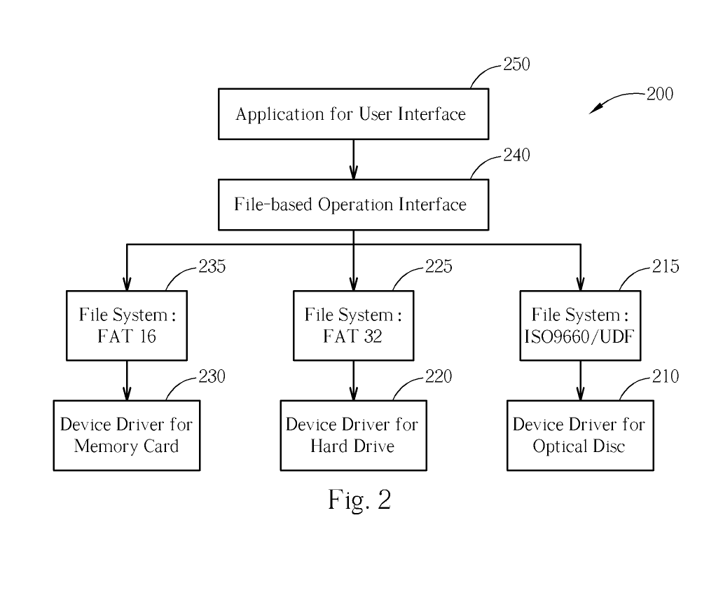

Turning now to FIG. 2, displaying the content of different data sources on a single user interface is based on a software system 200. The software system 200 is responsible for building a user interface independent of data sources and receiving user's operations. Different kinds of file systems may be applied to different kinds of data sources according to the characteristics of the data sources. For example, as shown in FIG. 2, the file system 215 of an optical disc is ISO9660 or UDF, while the file systems 225 and 235 of a hard drive and a memory card are FAT32 and FAT16, respectively. Therefore, software system 200 has a file-based operation interface 240 such that the application for user interface 250 is capable of utilizing the file systems 215, 225, 235 and translating user's operation into series of commands for a certain device driver. Finally, device drivers 210, 220 and 230 will execute the commands from the user interface and access the physical storage media.

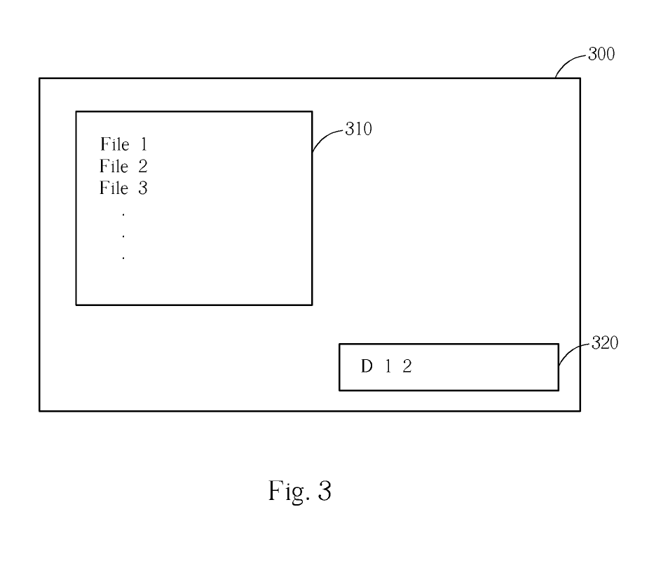

Please refer to FIG. 3, which shows an exemplary embodiment of a user interface 300. The user interface 300 shown on the display unit 111 provides a common display frame with two display spaces 310 and 320. Here a DVD player capable of accessing a plurality of external data sources is taken as an example of the consumer electronic device 100, and hence the main function of the DVD player is to read and decode data from a storage medium.

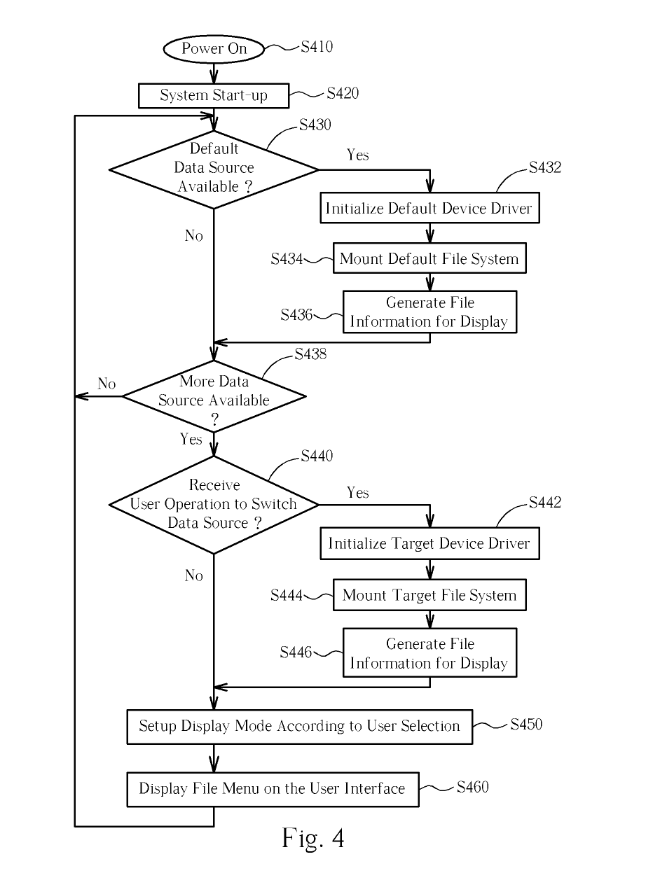

FIG. 4 shows the system flowchart of the consumer electronic device 100, i.e., the DVD player. Initially, after the DVD player is powered on (step S410), a system start-up process is performed to set the DVD player in a ready status (step S420). Next, it is detected if the default data source 180 is available (step S430), i.e., it is determined if an optical disc has been inserted into the DVD player. If an optical disc has been inserted, a default device driver is now initialized (step S432). A default file system is then mounted for the file-based operation interface 240 (step S434). Thereafter, file information of the inserted optical disc is collected and the content list of files contained in the optical disc is generated for display (step S436). Then it is detected if there are more data sources available in the DVD player (step S438). If there is no more data source available, it checks again if the default data source is available (step S430). If there is/are more data source(s) available, then it is checked to see if a user operation for switching data source is received or not (step S440). If the data source is switched to another one, then a target device driver is initialized (step S442) and a target file system is mounted accordingly (step S444). For this data source, file information is collected and its content list is also generated for display (step S446). Finally, a display mode is set according to the user selection (step S450) and the content list may be showed in the form of file menu on the display space 310 of the user interface 300 (step S460).

To further explain the above-mentioned system flowchart, an example is described as follows. It is assumed that an optical disc has been inserted into the DVD player. A first data source (a CF card for example) and a second data source (a portable hard drive for example) are added to the DVD player by coupling to corresponding I/O interfaces. As a result, the symbols such as: “D”, “1”, and “2”, indicative of the optical disc, the CF card and the portable hard drive, are shown on the display space 320. Please note, as shown in FIG. 3, the symbols shown on the display space 320 can be in the form of texture or iconic representation. When any one of the data sources is removed, the corresponding symbol vanishes from the user interface 300. In some embodiments, the symbols indicative of all possible data sources supported by the I/O interfaces are simultaneously showed on the user interface 300. After appropriate steps illustrated in FIG. 4 are finished, one of the three symbols can be selected. If the symbol “1” is actively selected, and therefore the symbol “1” is distinguished from the other unselected symbol or symbols by changing its color from a default color to a different specific color. As a result, the file names of the files contained in the CF card are shown on the display space 310. If user's selection is switched from the symbol “1” to symbol “2”, the portable hard drive is determined to be actively selected. Thus, the color of “1” is reset to the default color and the color of “2” is changed to the specific color, the content of the portable hard drive is detected, and the file names of the files contained in the portable hard drive are shown on the same display space 310. The controller 120 can activate the functionality associated with a file type to play a file of the same type in response to selection of the file. The functionality may be hardware circuitry, software components, or a combination. For example, the controller 120 automatically invokes the proper software required to execute a specific file, such as: an MP3 file, a JPEG file, or a DivX file.

Moreover, there are three optional switching rules supported by the user interface 300. To explain these three switching rules, it is assumed that the DVD player has two I/O interfaces coupled with an optical disc and a CF card, respectively. Furthermore, the DVD player has a third I/O interface for a SD card, which is left empty in this example, and three symbols (again “D”, “1” and “2” for example) are shown on the display space 320. The three switching rules are described as follows:

1. The first switching rule allows a user to switch only among the data sources present in the I/O interfaces. That is, only the optical disc and the CF card can be selected by the user through selecting one of the symbols “D” and “1” visible on the display space 320 of the user interface 300.

2. The second switching rule allows a user to switch among all possible data sources supported by the I/O interfaces of the DVD player even though a data source is not available. In the illustrative example, the symbol “2” is also visible and selectable on the user interface 300 although a SD card is not yet coupled to the third I/O interface. For instance a user simply presses a button on a remote controller to orderly switch among the three I/O interfaces. When the symbol “1” is actively selected, the display space 310 shows file names of the files contained in the CF card. However, if the symbol “2” is selected, a warning message is shown on the user interface 300 to notify the user that an appropriate data source is unavailable to the third I/O interface. In some embodiments, the symbol indicative of an unavailable data source is still visible but can be prevented from being selected.

3. The third switching rule allows a user to set a user-defined sequence for selection of a data source. In the illustrative example, the data sources supported by the three I/O interfaces are candidates for the user-defined sequence. For instance, a user-defined sequence like “D→2→1→D→2 . . . ” or “D→2→D→2 . . . ” can be set through the user interface 300. After a user-defined sequence has been set, user's selection can he confined to switch among the symbols indicative of the data sources dictated by the user-defined sequence. Additionally, the order of switching follows a user-defined sequence, if set.

In view of the above, only one single user interface is required and shown to present the content of different data sources. Regardless of which data source is selected, the file names of the files stored in the data source are listed on the same display space utilizing the same user interface. Therefore, control of a consumer electronic device becomes very easy and convenient.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a user interface of a consumer electronic device comprising a plurality of I/O interfaces for communication with a plurality of data sources, the method comprising:
utilizing the user interface to display a content list of a first data source present in the consumer electronic device if the first data source is active; and
when a second data source is added to the consumer electronic device and then actively selected, utilizing the same user interface to display a content list of the second data source.

2. The method of claim 1, further comprising:
adding the second data source by coupling to a corresponding I/O interface; and
showing on the user interface a symbol indicative of the second data source.

3. The method of claim 2, further comprising: showing on the user interface another symbol indicative of the first data source.

4. The method of claim 3, further comprising:
if user selection switches to the symbol indicative of the second data source, determining that the second data source is actively selected; and
detecting the content of the second data source such that the content list of the second data source is displayed through the user interface.

5. The method of claim 2, further comprising: when the second data source is removed from the corresponding I/O interface, erasing the symbol indicative of the second data source.

6. The method of claim 2, further comprising: showing on the user interface a plurality of symbols indicative of all possible data sources supported by the I/O interfaces of the consumer electronic device.

7. The method of claim 6, further comprising: if a symbol indicative of an unavailable data source is selected, displaying a warning message through the user interface; wherein the unavailable data source is a data source not yet coupled to a supporting I/O interface.

8. The method of claim 6, further comprising: preventing a symbol indicative of an unavailable data source from being selected if the data source is not yet coupled to a supporting I/O interface.

9. The method of claim 6, further comprising:
setting a user-defined sequence through the user interface; and
switching selection among the symbols in accordance with the user-defined sequence.

10. The method of claim 6, wherein the symbols are in the form of textual or iconic representation.

11. A method for controlling a user interface of a consumer electronic device, the consumer electronic device capable of communicating with a plurality of data sources, the method comprising:
if a first data source is present in the consumer electronic device and being active, utilizing the user interface to display a content list of the first data source; and
when a second data source is added to the consumer electronic device, utilizing the same user interface to display a content list of the second data source.

12. The method of claim 11, wherein the content list of the second data source is displayed through the user interface in response to selection of the second data source.

13. The method of claim 11, wherein the first and the second data sources are removable storage media.

14. The method of claim 11, wherein each of the content lists is displayed in the form of file names of files contained within a corresponding data source.

15. The method of claim 14, further comprising:
activating functionality associated with a file type in response to selection of a file listed on the user interface, wherein the selected file is of the file type; and
playing the selected file by the activated functionality.

16. The method of claim 11, further comprising:
providing the user interface with a common display frame;
if the first data source is actively selected, showing the content list of the first data source in the common display frame; and
if the second data source is actively selected, showing the content list of the second data source in the common display frame.

17. A consumer electronic device capable of communicating with a plurality of data sources, comprising:
a storage unit for storing a user interface program; and
a controller, coupled to the storage unit, operative to execute the user interface program and control a user interface shown on a display unit, wherein the user interface is controlled to display a content list of a first data source present in the consumer electronic device if the first data source is active, and when a second data source is added to the consumer electronic device and then actively selected, the same user interface is controlled to display a content list of the second data source.

18. The consumer electronic device of claim 17, further comprising a plurality of I/O interfaces for communication with a plurality of data sources.

19. The consumer electronic device of claim 18, wherein the second data source is added by coupling to a corresponding I/O interface, and wherein the controller controls the user interface to show a symbol indicative of the second data source and another symbol indicative of the first data source.

20. The consumer electronic device of claim 19, wherein if user selection switches to the symbol indicative of the second data source, the controller determines that the second data source is actively selected and detects the content of the second data source such that the content list of the second data source is displayed on the user interface.

21. The consumer electronic device of claim 19, wherein the controller controls the user interface to erase the symbol indicative of the second data source when the second data source is removed from the corresponding I/O interface.

22. The consumer electronic device of claim 19, wherein the controller controls the user interface to show the symbols in the form of textual or iconic representation.

23. The consumer electronic device of claim 18, wherein the controller controls the user interface to show a plurality of symbols indicative of all possible data sources supported by the I/O interfaces.

24. The consumer electronic device of claim 23, wherein the controller controls the user interface to display a warning message if a symbol indicative of an unavailable data source, which is a data source not yet coupled to a supporting I/O interface, is selected.

25. The consumer electronic device of claim 23, wherein the controller controls the user interface to prevent a symbol indicative of an unavailable data source from being selected if the data source is not yet coupled to a supporting I/O interface.

26. The consumer electronic device of claim 23, wherein the controller controls the user interface to allow input of a user-defined sequence, and controls the user interface to switch selection among the symbols in accordance with the user-defined sequence.

27. The consumer electronic device of claim 17, wherein the first and the second data sources are removable storage media.

28. The consumer electronic device of claim 17, wherein the controller controls the user interface to display each of the content lists in the form of file names of files contained within a corresponding data source.

29. The consumer electronic device of claim 28, wherein in response to selection of a file listed on the user interface, the controller activates functionality associated with a file type to play the selected file of the type.

30. The consumer electronic device of claim 17, wherein the user interface comprises a common display frame, and wherein the controller controls the user interface to show the content list of the first data source within the common display frame if the first data source is actively selected, and to show the content list of the second data source within the common display frame if the second data source is actively selected.
